(19) United States
(12) Patent Application Publication
(10) Pub. No.: US 2023/0146973 A1
(43) Pub. Date: May 11, 2023

(54) COLLECTIVE INTELLIGENCE SYSTEMS, METHODS, AND DEVICES

(71) Applicant: Futureloop Inc., Culver City, CA (US)

(72) Inventors: Peter H. Diamandis, Santa Monica, CA (US); Morgan Rawls-McDermott, Portland, OR (US); Eben Pagan, Sunny Isles Beach, FL (US)

(73) Assignee: Futureloop Inc., Culver City, CA (US)

(21) Appl. No.: 17/950,428

(22) Filed: Sep. 22, 2022

Related U.S. Application Data
(63) Continuation of application No. PCT/IB2021/052370, filed on Mar. 23, 2021.
(60) Provisional application No. 62/994,795, filed on Mar. 25, 2020.

(51) Int. Cl. G06Q 30/0203; G06Q 30/0202

(52) U.S. Cl. CPC G06Q 30/0203; G06Q 30/0202

(57) ABSTRACT

A collective intelligence system includes presenting a poll question to a group of users; collecting user responses to the poll question, at least some of the user responses including a corresponding user reason; determining an aggregated prediction based on the user responses; determining a set of aggregated reasons based on user reasons provided with the user responses; presenting a summary of the user responses, the summary including the aggregated prediction and an aggregated reason corresponding to the aggregated prediction; collecting modified user responses to the poll question, at least some of the user-modified responses including a corresponding modified user reason, wherein the modified user reason is selected from the set of aggregated reasons; determining an updated aggregated prediction based on the modified user responses; and presenting a summary of the user responses, the summary including the updated aggregated prediction and an aggregated reason corresponding to the aggregated prediction.

### COPYRIGHT STATEMENT

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### RELATED APPLICATIONS

This application is a continuation of PCT/IB2021/052370, filed Mar. 23, 2021, which claims the benefit of U.S. Provisional Patent Application No. 62/994,795, filed Mar. 25, 2020, the entire contents of each of which are hereby fully incorporated herein by reference for all purposes.

### FIELD OF THE INVENTION

This invention relates to collective intelligence and, more specifically, to systems, methods, and devices for determining and evaluating the collective intelligence of one or more groups.

### BACKGROUND

Every year, exponentially more data, including news, is produced and made available digitally to anyone in the world who has access to the Internet. This overwhelm of information makes it challenging for individual humans to use this information to make accurate predictions about the future of themselves, their family, their locality, and the world.

When humans assemble into groups, we are able to process exponentially more information and come to superior aggregate predictions. Current mechanisms for polling group sentiment, however, are lacking in a few key areas. Editorial news analyses are sensationalized and biased by the author, group polls and “swarm intelligence” systems lack interpretability, and social media inevitably devolves into a one-sided echo chamber. Most importantly, users are presented with few technological means to sift through these analyses and uncover true insight.

It is desirable and an object here to provide users with better ways to sift through analyses and uncover valuable insight.

Systems exist to enable groups of networked people to answer questions, make predictions, and offer opinions. However, these systems do not provide reasons why the group members made their decisions or provide users with ways to be persuaded by other group members.

It is desirable and an object hereof to enable groups of networked people to answer questions, make predictions, offer opinions, and provide information that allows group members to change their responses.

It is further desirable and a further object hereof to weight the responses (e.g., answers, predictions, opinions) of certain group members differently.

### SUMMARY

The present invention is specified in the claims and in the description below. Preferred embodiments are particularly specified in the dependent claims and the description of various embodiments.

In some aspects, we have created a system that uses machine learning and human intelligence in a symbiotic loop that iterates to produce accurate aggregate predictions and surfaces anonymized justifications behind those predictions.

Aspects hereof use machine learning to anonymize and aggregate thousands or even millions of user-submitted predictions and justifications, present that analysis to users, allow users to interrogate the analysis, and then allow users to update their estimates in an ongoing fashion.

According to some aspects, users can vote on the machine-learning aggregated reasons that other users provided for their predictions, providing an additional layer of crowd-filtering. These upvoted predictions and reasons rise to the top and are presented to all users so that the entire collective becomes more informed and can update their votes to form a more accurate aggregate prediction.

A system of one or more computers can be configured to perform particular operations or actions by virtue of having software, firmware, hardware, or a combination of them installed on the system that, in operation, causes or cause the system to perform the actions. One or more computer programs can be configured to perform particular operations or actions by virtue of including instructions that, when executed by data processing apparatus, cause the apparatus to perform the actions.

One general aspect includes a method including (a) presenting a poll question to a group of users. The method also includes (b) collecting user responses to the poll question, at least some of the user responses including a corresponding user reason. The method also includes (c) determining an aggregated prediction based on the user responses. The method also includes (d) determining a set of aggregated reasons based on user reasons provided with the user responses. The method also includes (e) presenting a summary of the user responses, the summary including the aggregated prediction, and an aggregated reason corresponding to the aggregated prediction. The method also includes (f) in response to the presenting, collecting modified user responses to the poll question, at least some of the user-modified responses including a corresponding modified user reason, where the modified user reason is selected from the set of aggregated reasons. The method also includes (g) in response to the collecting in (f), determining an updated aggregated prediction based on the modified user responses. The method also includes (h) presenting a summary of the user responses, the summary including the updated aggregated prediction, and an aggregated reason corresponding to the aggregated prediction. Other embodiments of this aspect include corresponding computer systems, apparatus, and computer programs recorded on one or more computer storage devices, each configured to perform the actions of the methods.

Implementations may include one or more of the following features, alone and/or in combination(s):
The method where the poll question may include a preset collection of responses; and/or
The method where the user reasons collected in (b) may include a free-form textual user input; and/or
The method where the collecting in (b) occurs asynchronously; and/or
The method where the aggregated prediction is determined as a simple average; and/or
The method where the aggregated prediction is determined as a weighted average; and/or
The method where the weighted average is determined using one or more weights based on user information; and/or
The method where the user information used to determine the one or more weights is selected from one or more of age, gender, location, and profession; and/or
The method where the user information for a particular user is based on a measure of accuracy of prior predictions made by the particular user; and/or
The method where the set of aggregated reasons may include a set of anonymized, aggregated, and/or rewritten reasons; and/or
The method where the user reasons are aggregated and/or rewritten by machine learning; and/or
The method where determining the set of aggregated reasons in (d) may include: converting the user reasons into high dimensional vectors using an embedding model; applying a transformation to each textual input embedding such that the embeddings better cluster; clustering the transformed textual input embeddings; and summarization and rewriting texts that have been clustered. Implementations of the described techniques may include hardware, a method or process, or computer software on a computer-accessible medium.

Implementations of the described techniques may include hardware, a method or process, or computer software on a computer-accessible medium.

Below is a list of method or process embodiments. Those will be indicated with the letter “P.”
P1. A method comprising:
   (A) presenting a poll question to a group of users;
   (B)collecting user responses to the poll question, at least some of the user responses including a corresponding user reason;
   (C)determining an aggregated prediction based on the user responses;
   (D) determining a set of aggregated reasons based on user reasons provided with the user responses;
   (E)presenting a summary of the user responses, the summary including the aggregated prediction and an aggregated reason corresponding to the aggregated prediction;
   (F) in response to the presenting, collecting modified user responses to the poll question, at least some of the user-modified responses including a corresponding modified user reason, wherein the modified user reason is selected from the set of aggregated reasons;
   (G) in response to the collecting in (F), determining an updated aggregated prediction based on the modified user responses; and
   (H) presenting a summary of the user responses, the summary including the updated aggregated prediction and an aggregated reason corresponding to the aggregated prediction.
P2. The method of embodiment P1, wherein the poll question comprises a preset collection of responses.
P3. The method of embodiments P1 or P2, wherein the user reasons collected in (B) comprise a free-form textual user input.
P4. The method of any of the preceding embodiments, wherein the collecting in (B) occurs asynchronously.
P5. The method of any of the preceding embodiments, wherein the aggregated prediction is determined as a simple average.
P6. The method of any of the preceding embodiments, wherein the aggregated prediction is determined as a weighted average.
P7. The method of embodiment P6, wherein the weighted average is determined using one or more weights based on user information.
P8. The method of embodiment P7, wherein the user information used to determine the one or more weights is selected from one or more of age, gender, location, and profession.
P9. The method of embodiment P7, wherein the user information for a particular user is based on a measure of accuracy of prior predictions made by the particular user.
P10. The method of any of the preceding embodiments, wherein the set of aggregated reasons comprises a set of anonymized, aggregated, and/or rewritten reasons.
P11. The method of any of the preceding embodiments, wherein the user reasons are aggregated and/or rewritten by machine learning.
P12. The method of any of the preceding embodiments, wherein the determining of the set of aggregated reasons in (D) comprises:
   converting the user reasons into high dimensional vectors using an embedding model;
   applying a transformation to each textual input embedding such that the embeddings better cluster;
   clustering the transformed textual input embeddings; and
   summarization and rewriting texts that have been clustered.

Below is a list of article of manufacture embodiments. Those will be indicated with the letter “A.”
A13. An article of manufacture comprising non-transitory computer-readable media having computer-readable instructions stored thereon, the computer-readable instructions including instructions for implementing a computer-implemented method, the method operable on a device comprising hardware including memory and at least one processor and running a service on the hardware, the method comprising the method of any one of the preceding method aspects or embodiments P1-P12.

Below is a list of device embodiments. Those will be indicated with the letter “D.”
D14. A device comprising:
   (a) hardware including memory and at least one processor, and
   (b) a service running on the hardware, wherein the service is configured to perform the method of any one of the preceding method aspects or embodiments P1-P12.

Below is a list of system embodiments. Those will be indicated with the letter “S.”
S15. A system comprising at least one device according to device embodiment(s) D16.

The above features and additional details of the invention are described further in the examples herein, which are intended to further illustrate the invention but are not intended to limit its scope in any way.

### BRIEF DESCRIPTION OF THE DRAWINGS

Other objects, features, and characteristics of the present invention, as well as the methods of operation and functions of the related elements of structure, and the combination of parts and economies of manufacture, will become more apparent upon consideration of the following description and the appended claims with reference to the accompanying drawings, all of which form a part of this specification. None of the drawings are to scale unless specifically stated otherwise.

FIG. 1 shows an overview of aspects of a collective intelligence framework according to exemplary embodiments hereof;

FIGS. 2A-2C shows aspects of data structures used according to exemplary embodiments hereof;

FIG. 3A-3D show screenshots of aspects of an exemplary implementation of a collective intelligence framework according to embodiments hereof;

FIGS. 4A-4C are flowcharts showing aspects of a collective intelligence framework according to exemplary embodiments hereof; and

FIG. 5 depicts aspects of computing and computer devices in accordance with exemplary embodiments hereof.

### DETAILED DESCRIPTION OF THE PRESENTLY PREFERRED EXEMPLARY EMBODIMENTS

As used herein, the term “mechanism” refers to any device(s), process(es), service(s), or combination thereof. A mechanism may be implemented in hardware, software, firmware, using a special-purpose device, or any combination thereof. A mechanism may be integrated into a single device, or it may be distributed over multiple devices. The various components of a mechanism may be co-located or distributed. The mechanism may be formed from other mechanisms. In general, as used herein, the term “mechanism” may thus be considered shorthand for the term device(s) and/or process(es) and/or service(s).

### Overview and Structure

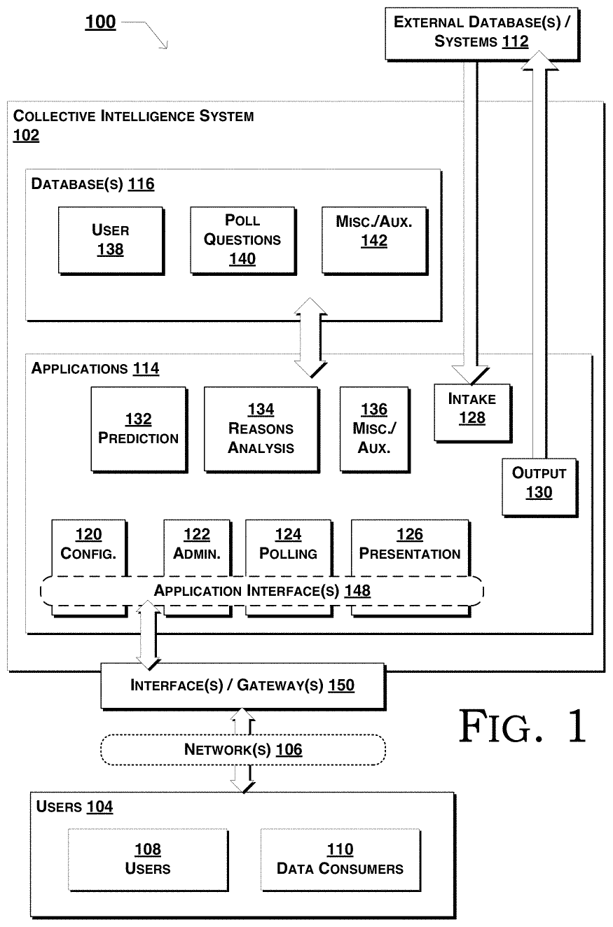

FIG. 1 shows aspects of an exemplary framework/system 100 for a collective intelligence system 102 according to exemplary embodiments hereof. As shown in the drawing, a collective intelligence system 102 may be accessed by users 104, e.g., via one or more networks 106 (e.g., the Internet). For example, as shown in FIG. 1, the users 104 may include users 108 and data consumers 110. This list of types of users is exemplary, and the users 104 may include different and/or other types of users.

The users 104 may have distinct roles and may be provided with role-specific access interfaces and/or mechanisms.

Each user 104 may access the collective intelligence system 102 using one or more computing devices, as is known in the art. The collective intelligence system 102 may also access and be accessible by various external systems and/or databases 112. These external systems and/or databases 112 may include social media sites such as Twitter, Facebook, Email, blogs, stock and/or commodity price databases, weather databases, etc.

As shown in FIG. 1, the collective intelligence system 102 (sometimes referred to as the “backend” or “backend platform”) may comprise various mechanisms or applications 114 (e.g., in the form of software applications) and one or more databases 116, described in greater detail below. The mechanisms 114 may generally interact with the one or more databases 116.

The database(s) 116 may be or comprise multiple separate or integrated databases, at least some of which may be distributed. The database(s) 116 may be implemented in any manner, and when made up of more than one database, the various databases need not all be implemented in the same manner. It should be appreciated that the system is not limited by the nature or location of the database(s) 116 or by the manner in which they are implemented.

Each of the applications 114 is essentially a mechanism (as defined above, e.g., a software application) that may provide one or more services via an appropriate interface. Although shown as separate mechanisms for the sake of this description, it should be appreciated that some or all of the various mechanisms 114 may be combined. The various mechanisms 114 may be implemented in any manner and need not all be implemented in the same manner (e.g., with the same languages or interfaces, or protocols).

The mechanisms 114 may include one or more of the following mechanisms:
1. configuration mechanism(s) 120
2. administrative mechanism(s) 122
3. polling mechanism(s) 124
4. presentation mechanism(s) 126
5. Intake mechanism(s) 128
6. Output mechanism(s) 130
7. Prediction mechanism(s) 132
8. Reasons analysis mechanism(s) 134
9. Miscellaneous/auxiliary mechanisms 136

Note that the above list of mechanisms/mechanisms is exemplary and is not intended to limit the scope of the system 100 in any way. Those of ordinary skill in the art will appreciate and understand, upon reading this description, that the system 100 may include any other types of data processing mechanisms, image recognition mechanisms, and/or other types of mechanisms that may be necessary for the system 100 to generally perform its functionalities as described herein. In addition, as should be appreciated, embodiments or implementations of the system 100 need not include all of the mechanisms listed, and some or all of the mechanisms may be optional.

The database(s) 116 may include one or more of the following database(s):
1. User database(s) 138
2. Poll Question(s) 140
3. Miscellaneous and auxiliary database(s) 142

The above list of databases is exemplary and is not intended to limit the scope of the system 100 in any way.

As shown in FIG. 1, the collective intelligence system 102 may access one or more external systems and databases 112. This access may include access via intake mechanism(s) 128, which may access external systems to obtain data therefrom. Access via output mechanism(s) 130 may be used to provide information (e.g., poll response information) to the external systems and/or databases 112. The miscellaneous/auxiliary mechanisms 136 may evaluate data (e.g., obtained from external systems and databases 112 and/or in the database(s) 116) to determine information therefrom.

Various mechanisms in the collective intelligence system 102 may be accessible via application interface(s) 148. These application interfaces 148 may be provided in the form of APIs (application programming interfaces) or the like, made accessible to external users 104 via one or more gateways and interfaces 150. For example, the polling mechanism(s) 124 may provide APIs thereto (via application interface(s) 148), and the system 102 may provide external access to aspects of the presentation mechanism(s) 126 (to users 104) via appropriate gateways and interfaces 150 (e.g., via a web-based mechanism and/or a mechanism running on a user's device).

### Mechanisms and Data Structures

Details of various mechanisms, processes, and functionalities of an exemplary collective intelligence system 102 are now described.

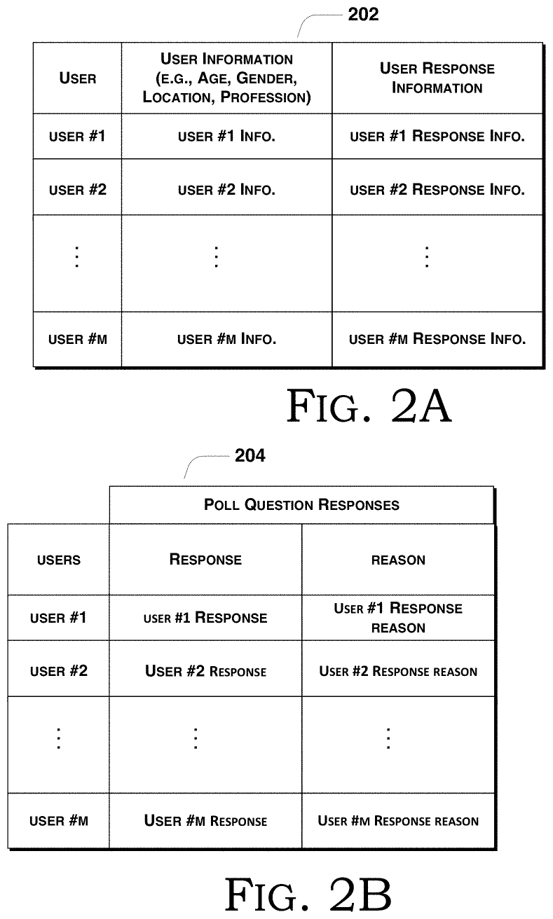

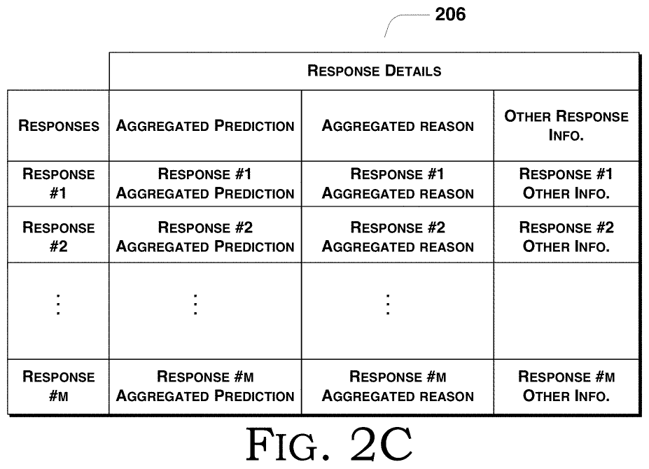

The user database 138 may include user data 202 (FIG. 2A), which may include, for each of multiple users, user information (e.g., age, gender, location, profession, etc.) and user response information (described in greater detail below).

The poll questions database 140 may include poll question information, including, e.g., poll questions, poll question responses 204 (FIG. 2B), and poll question response details 206 (FIG. 2C).

### Exemplary Operation

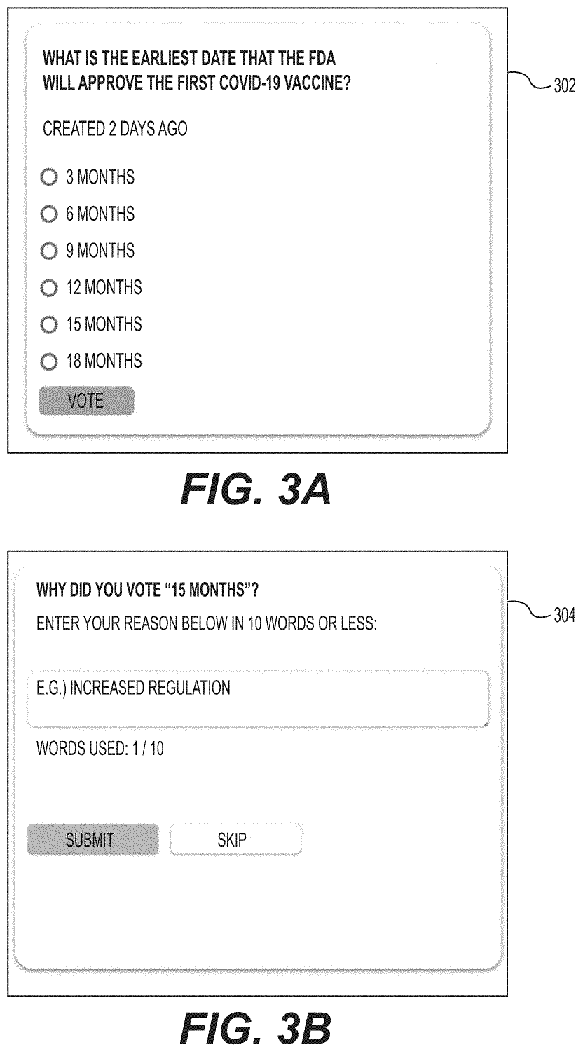

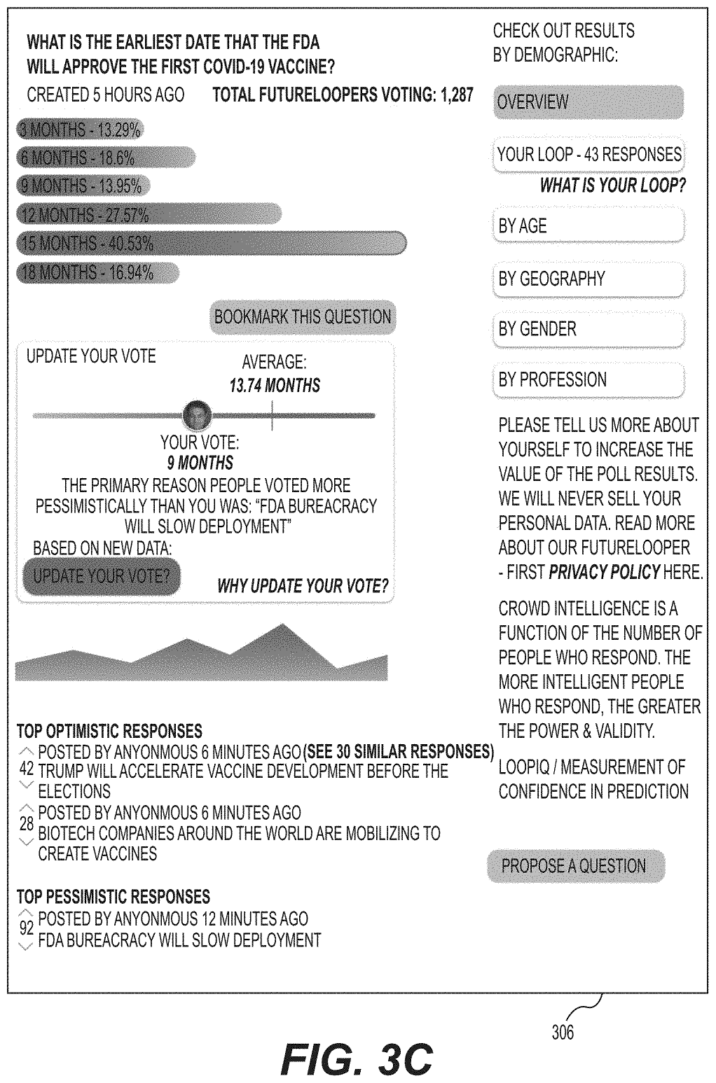

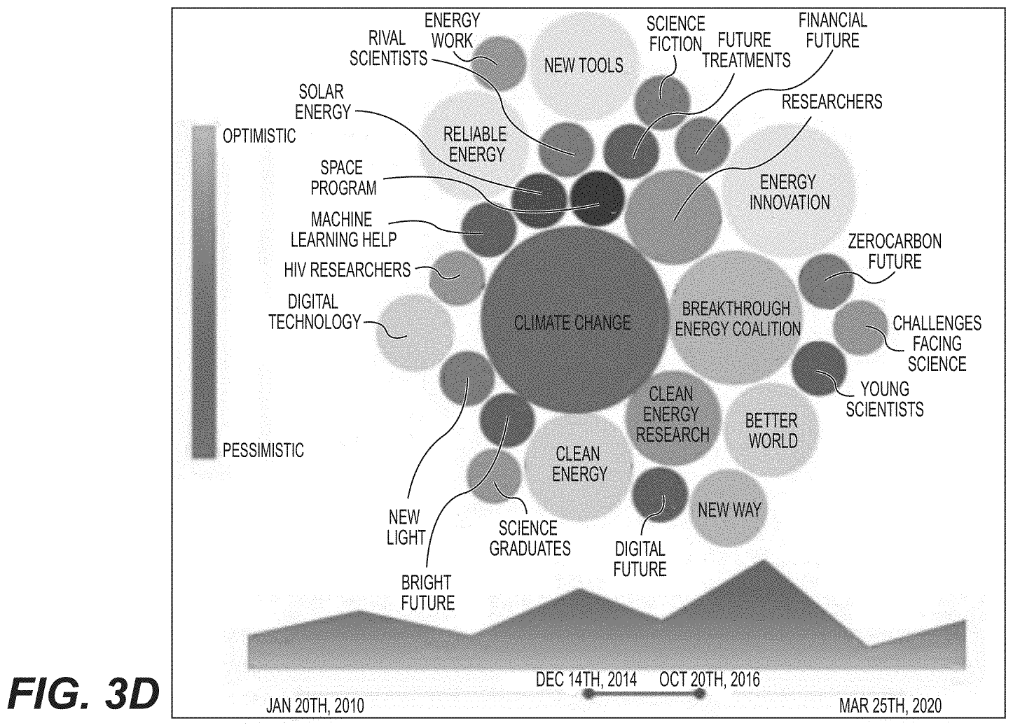

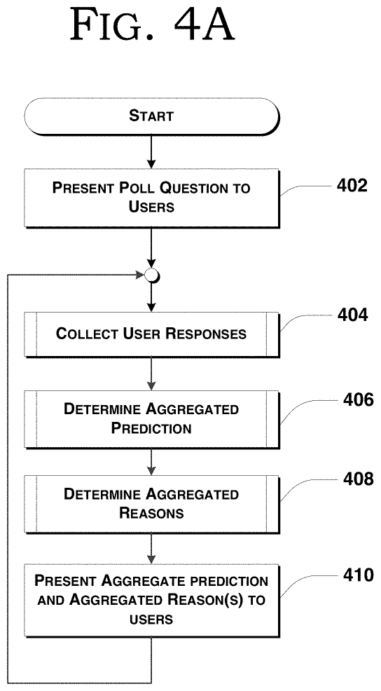

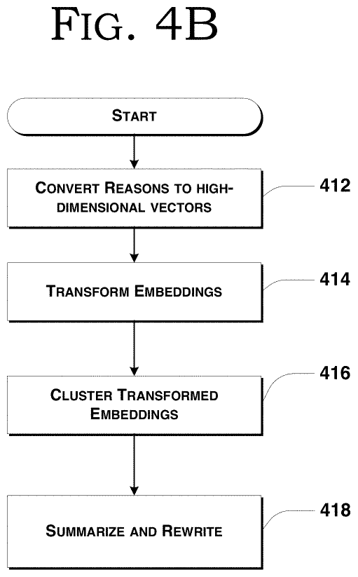

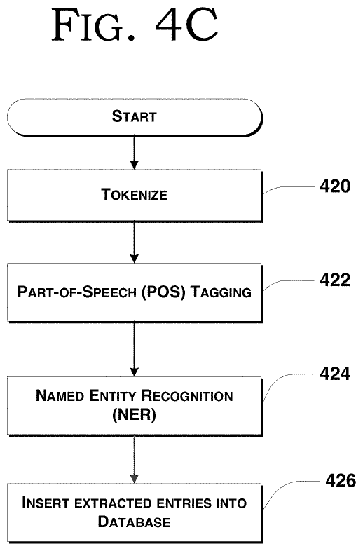

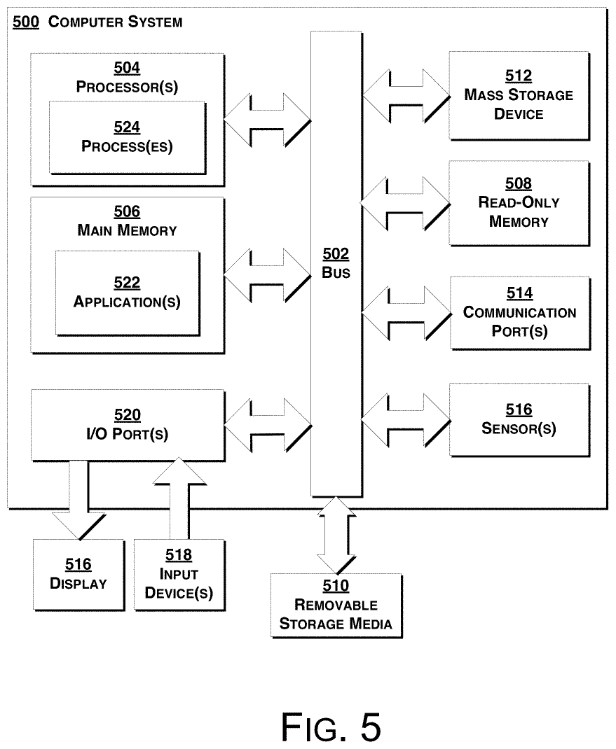

An overview of exemplary operation of a framework/system 100 is described here with reference to the screenshots in FIGS. 3A and the flowchart in FIG. 4A.

Users (e.g., users 108) are presented with a poll question (at 402), e.g., using polling mechanism(s) 124. An example poll question is shown in FIG. 3A. The polling question preferably allows user selection from a preset collection of responses and/or direct input of a numerical value (e.g., 18) via text input or by graphically selecting a particular value on a scale. For example, in the poll question shown in FIG. 3A, a user may select from one of six responses. Once a user chooses a response, they may provide a reason or justification for their vote. The reason may be provided from a list of preset reasons and/or as free-form textual input from the user (see, e.g., FIG. 3B).

The polling mechanism(s) 124 collect (at 404) each user's responses (including any reasons given by the users). For each user that responds, the polling mechanism(s) 124 may maintain and store that user's response and response reason (if given). The user responses may be maintained and stored in the poll questions database(s) 140, e.g., using a data structure such as the poll question responses 204 shown in FIG. 2B.

The responses may be collected asynchronously over time.

The prediction mechanism(s) 132 may then (at 406) determine an aggregate prediction from the collected response (e.g., as a simple average of all submitted votes or via a more complex algorithm, as discussed below).

The reasons analysis mechanism(s) 134 may (at 408) determine a set of aggregated reasons based on the reasons given in user responses. Reasons provided by users are preferably anonymized, aggregated, and, optionally, rewritten, e.g., via machine learning (ML—discussed below).

Users are then presented (at 410, e.g., by presentation mechanism(s) 126) with the aggregate prediction (determined at 406) and the aggregated reason (determined at 408). The users may also be presented with a summary of all votes. An example presentation is shown in FIG. 3C.

Having seen the aggregated results (prediction and reasons), users may update their votes (the polling mechanism(s) 124 essentially repeat steps 404 to 410.

Users are preferably prompted to update their vote immediately upon viewing the results of the aggregate.

In updating their vote, a user may change their vote and/or reason.

However, in some cases, in updating a vote, a user may only be permitted to select a reason from the set of aggregated reasons (determined at 408).

Polls may be ongoing, and users may update their vote, e.g., every day. The system may set constraints on how often users may update their votes and/or reasons.

The aggregate prediction may then be plotted over time to show trends in aggregate sentiment.

These aggregated reasons are upvoted and downvoted by users, then may be sorted by a number of algorithms.

The presentation mechanism(s) 126 may allow and support poll responses and associated reasons to be segmented, e.g., by selecting demographic properties of the participating users. Thus, e.g., in the example shown in FIGS. 3A-3C, the poll responses may be segmented by age, geographic location, gender, and/or profession. Those of skill in the art will understand, upon reading this description, that these categories are merely exemplary and that different and/or other categories may be used to segment and/or analyze poll data.

### Aggregate Vote Scoring Prediction

As noted above, the prediction mechanism(s) 132 may (at 406) determine an aggregate prediction from the collected response. There are many possible ways to possibly interpret the provided reasons and votes to form an accurate aggregate prediction, examples of which are provided below.

Many of these strategies involve assigning weights to individual votes, in which case the final prediction is given by:

$$( {\sum }_{v o t e s} v a l u {e}_{v o t e} * {weight}_{v o t e} ) / ( {\sum }_{v o t e s} {weight}_{v o t e} )$$

Simple Strategies

A simple mean, median, or mode of all provided vote values.

General Weighted Vote Strategies

E.g., increase the weight of votes that have been updated by their user and/or weight each vote in inverse proportion to its age. As should be appreciated, different and/or other weighting factors may be used.

User-Based Strategies

Weight each vote by the known predictive error of the user who made it. As a user completes many polls over time, the system may gather data allowing it to estimate a user's likely predictive error.

For example, data for the outcomes may be gathered by asking users to predict objectively measurable events such as, e.g., the closing price of the Dow Jones Industrial index or the number of people infected by COVID-19 on any given day. The collected data may be compared with actual data to determine each user's predictive accuracy as well as the accuracy of the group of users.

This approach allows the system to identify “super-forecasters” within an organization who often predict accurately within a certain domain.

Statistical and Machine Learning Methods

Given available votes, the context in which they were made, and available data about users who made those votes as input, the system may create a machine learning model trained to predict the final outcome. The system may use actual data (as described above) to train an ML model.

### Reason Scoring

The reasons analysis mechanism(s) 134 may score reasons based on votes (e.g., “upvotes”) given by users participating in the poll.

There are several ways to “score” reasons in order to determine the “Top Reasons,” “Top Optimistic Reasons,” and “Top Pessimistic Reasons.” These methods include, e.g., and without limitation:
Simple reason-scoring methods
   a Total number of upvotes−total number of downvotes
   (Total number of upvotes−total number of downvotes)/age of reason
Per-user customization
   Based on a user's interactions with articles, reasons, and polls, as well as their digital footprint on other social media sites such as Twitter, Facebook, Email, and Blogs, the system may determine the likelihood that a user would agree or disagree with a given reason. These reasons can be presented as “Reasons you might agree with.”

| | Agree | Disagree |
|---|---|---|
| More | Reasons a user might agree | Reasons a user might disagree |
| Pessimistic | with that support a more | with that support a more |
| | pessimistic position than the | pessimistic position than the |
| | user voted for | user voted for |
| More | Reasons a user might agree | Reasons a user might disagree |
| Optimistic | with that support a more | with that support a more |
| | optimistic position than the | optimistic position than the user |
| | user voted for | voted for |

### Reason Aggregation

As noted above, the reasons analysis mechanism(s) 134 may (at 408) determine aggregated reasons based on the reasons given in user responses. Reasons may be aggregated, e.g., to allow users to understand the prevailing optimistic and pessimistic perspectives at-a-glance.

An exemplary reason aggregation process is described here with reference to the flowchart in FIG. 4B. Those of skill in the art will understand, upon reading this description, that different and/or other reason aggregation processes may be used.

First, reasons (textual inputs) are converted into high dimensional vectors (at 412), e.g., via an embedding model. Common embedding models include Word2Vec, GloVe, Autoencoders, or utilizing the activations of a non-terminal layer in an Artificial Neural Network, such as Transformer-based Language Model (BERT, GPT-2, etc.).

The system then may optionally apply a transformation to each embedding (at 414) such that all embeddings better cluster into groups humans can understand. Several types of transformations may be used here, e.g.,
a. Masking (zeroing or deleting) features (dimensions) from each vector that are irrelevant to determining if reasons belong to the same cluster, as determined by a classification model such as a random forest or neural network.
b. Multiplying each feature of each vector by some weight determined by its importance to the overall cluster classification.
c. PCA, LDA, or other dimensionality reduction techniques.

Then, the optionally transformed textual input embeddings may be clustered (at 418), e.g., via an algorithm such as K-Means or DBSCAN. This clustering algorithm produces clusters and centroids for each cluster. These centroids serve as representatives whose associated text can be used as a proxy for all reasons whose embeddings are contained in its cluster.

Texts that have been clustered by the above algorithm may then be fed into a summarization and rewriting algorithm (at 418) to improve quality and anonymity. Such algorithms include, broadly, Sequence-to-Sequence models and, specifically, encoder-decoder architectures or Language Models conditioned on the cluster's texts.

### Temporal Reason Analysis

To analyze how the aggregate prediction changes over time, users may visualize: (A) how the frequency of different entities and sentence fragments contained within reasons change over time and (B) how those entities and sentence fragments correlate with optimistic or pessimistic votes (or votes corresponding to high/low values, or categorical values).

An example of such a visualization is shown in FIG. 3D.

To produce the visualization shown in FIG. 3D, the provided reasons for a poll were analyzed as follows (with reference to the flowchart in FIG. 4C):
1. Tokenize each reason's text (at 420), transforming sentences into either a collection of tokens representing words, compounds, and punctuation or representing sub-word character fragments.
2. Perform Part-of-Speech (POS) tagging on each provided reason (at 422), using, e.g., Transformer-based Language Models with a POS head, feed-forward neural networks, recurrent neural networks, or rule and statistical-based techniques.
3. Perform Named Entity Recognition (NER) on the tagged phrases (at 424). This may be done jointly with step (2) if allowed by the underlying predictive model.
4. Insert the extracted entities into a relational or graph database (at 426).

The database may then be queried for all entities identified in reasons that explain votes made during a provided time period for a particular question, made by users matching various demographic constraints. This query may optionally return aggregate statistics regarding the vote values associated with each entity, such as total votes, total votes greater than the mean, total votes less than the mean, mean of all associated votes, median, mode, standard deviation, and variance. For efficiency, the query may also aggregate these statistics by time period, for example, returning the mean vote value for each day that an entity was recognized within a provided reason.

### Users and User Selection

As described above, the users 104 may include users 108 who respond to poll questions. Users 108 may be selected from groups of people with given interests and/or expertise in certain areas. The users may be separated into groups or cohorts based, e.g., on their interests, expertise, locations, relationship with each other, etc.

In some embodiments, one or more of the users may be trained AI mechanisms with expertise in certain areas. The AI mechanisms may be trained based on the expertise and/or works of certain known experts or people whose predictive capabilities are considered accurate and/or useful (e.g., based on their writings, publications, prior predictions, business success, etc.).

For example, based on the social media posts created by Peter Diamandis, Ray Kurzweil, and Elon Musk, machine learning models may be trained that predict which user-submitted prediction reasons they would agree with and thereby how they would predict certain events. Those machine learning models may then be used to predict, for example, the year in which most automobiles will be electric powered.

These machine learning models may also be created for any ordinary user of our platform, allowing us to estimate an aggregate prediction across any arbitrary set of users (including all users) in real-time. For example, we could create machine learning models representing all users who are medical doctors and have those models in aggregate predict the year in which the FDA approves a cure for ALS.

### Computing

The services, mechanisms, operations, and acts shown and described above are implemented, at least in part, by software running on one or more computers or computer systems or devices. It should be appreciated that each user device is or comprises a computer system.

Programs that implement such methods (as well as other types of data) may be stored and transmitted using a variety of media (e.g., computer-readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers, and computing devices. One or more such computers or computing devices may be referred to as a computer system.

FIG. 5 is a schematic diagram of a computer system 500 upon which embodiments of the present disclosure may be implemented and carried out.

According to the present example, the computer system 500 includes a bus 502 (i.e., interconnect), one or more processors 504, a main memory 506, read-only memory (ROM) 508, removable storage media 510, and mass storage 512, and one or more communications ports 514. Communication port(s) 514 may be connected to one or more networks (not shown) whereby the computer system 500 may receive and/or transmit data.

As used herein, a “processor” means one or more microprocessors, central processing units (CPUs), graphics processing units (GPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 504 can be (or include) any known processor, such as but not limited to an Intel® Itanium® or Itanium 2® processor(s), AMD® Opteron® or Athlon MP® processor(s), or Motorola® lines of processors, and the like.

Communications port(s) 514 can be any of an RS-232 port for use with a modem-based dial-up connection, a 10/100 Ethernet port, a Gigabit port using copper or fiber, a USB port, and the like. Communications port(s) 514 may be chosen depending on a network such as a Local Area Network (LAN), a Wide Area Network (WAN), a CDN, or any network to which the computer system 500 connects. The computer system 500 may be in communication with peripheral devices (e.g., display screen 516, input device(s) 518) via Input/Output (I/O) port 520. Some or all of the peripheral devices may be integrated into the computer system 500, and the input device(s) 518 may be integrated into the display screen 516 (e.g., in the case of a touch screen).

Main memory 506 may be Random Access Memory (RAM) or any other dynamic storage device(s) commonly known in the art. Read-only memory 508 can be any static storage device(s) such as Programmable Read-Only Memory (PROM) chips for storing static information such as instructions for processor(s) 504. Mass storage 512 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 502 communicatively couples processor(s) 504 with the other memory, storage, and communications blocks. Bus 502 can be a PCI/PCI-X, SCSI, a Universal Serial Bus (USB) based system bus (or other) depending on the storage devices used and the like. Removable storage media 510 can be any kind of external hard-drives, floppy drives, IOMEGA® Zip Drives, Compact Disc-Read Only Memory (CD-ROM), Compact Disc-Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) that may be read by a computer, a processor or a like device. Such a medium may take many forms, including but not limited to non-volatile media, volatile media, and transmission media. Non-volatile media include, for example, optical or magnetic disks and other persistent memory. Volatile media include dynamic random-access memory, which typically constitutes the main memory of the computer. Transmission media include coaxial cables, copper wire, and fiber optics, including the wires that comprise a system bus coupled to the processor. Transmission media may include or convey acoustic waves, light waves, and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other types of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer-readable media may be involved in carrying data (e.g., sequences of instructions) to a processor. For example, data may be (i) delivered from RAM to a processor; (ii) carried over a wireless transmission medium; (iii) formatted and/or transmitted according to numerous formats, standards, or protocols; and/or (iv) encrypted in any of a variety of ways well known in the art.

A computer-readable medium can store (in any appropriate format) those program elements that are appropriate to perform the methods.

As shown, main memory 506 is encoded with applications(s) 522 that support(s) the functionality as discussed herein (an application 522 may be a mechanism that provides some or all of the functionality of one or more of the mechanisms described herein). Application(s) 522 (and/or other resources as described herein) can be embodied as software code such as data and/or logic instructions (e.g., code stored in the memory or on another computer-readable medium such as a disk) that supports processing functionality according to different embodiments described herein.

During operation of one embodiment, processor(s) 504 accesses main memory 506 via the use of bus 502 to launch, run, execute, interpret, or otherwise perform the logic instructions of the application(s) 522. Execution of application(s) 522 produces processing functionality of the service(s) or mechanism(s) related to the application(s). In other words, the process(es) 524 represents one or more portions of the application(s) 522 performing within or upon the processor(s) 504 in the computer system 500.

It should be noted that in addition to the process(es) 524 that carries(carry) out operations as discussed herein, other embodiments herein include the application 522 itself (i.e., the un-executed or non-performing logic instructions and/or data). The application 522 may be stored on a computer-readable medium (e.g., a repository) such as a disk or optical medium. According to other embodiments, the application 522 can also be stored in a memory type system such as in firmware, read-only memory (ROM), or, as in this example, as executable code within the main memory 506 (e.g., within Random Access Memory or RAM). For example, application 522 may also be stored in removable storage media 510, read-only memory 508, and/or mass storage device 512.

Those skilled in the art will understand that the computer system 500 can include other processes and/or software and hardware components, such as an operating system that controls the allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware, or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

### CONCLUSION

As used in this description, the term “portion” means some or all. So, for example, “A portion of X” may include some of “X” or all of “X.” In the context of a conversation, the term “portion” means some or all of the conversation.

As used herein, including in the claims, the phrase “at least some” means “one or more” and includes the case of only one. Thus, e.g., the phrase “at least some ABCs” means “one or more ABCs” and includes the case of only one ABC.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by the use of the word “only,” the phrase “based on X” does not mean “based only on X.”

As used herein, including in the claims, the phrase “using” means “using at least” and is not exclusive. Thus, e.g., the phrase “using X” means “using at least X.” Unless specifically stated by the use of the word “only,” the phrase “using X” does not mean “using only X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y” and does not mean that “X is fully distinct from Y.” Thus, as used herein, including in the claims, the phrase “X is distinct from Y” means that X differs from Y in at least some way.

As used herein, including in the claims, a list may include only one item, and unless otherwise stated, a list of multiple items need not be ordered in any particular manner A list may include duplicate items. For example, as used herein, the phrase “a list of XYZs” may include one or more “XYZs.”

It should be appreciated that the words “first” and “second” in the description and claims are used to distinguish or identify and not to show a serial or numerical limitation. Similarly, the use of letter or numerical labels (such as “(a),” “(b),” and the like) are used to help distinguish and/or identify and not to show any serial or numerical limitation or ordering.

No ordering is implied by any of the labeled boxes in any of the flow diagrams unless specifically shown and stated. When disconnected boxes are shown in a diagram, the activities associated with those boxes may be performed in any order, including fully or partially in parallel.

As used herein, including in the claims, singular forms of terms are to be construed as also including the plural form and vice versa unless the context indicates otherwise. Thus, it should be noted that as used herein, the singular forms “a,” “an,” and “the” include plural references unless the context clearly dictates otherwise.

Throughout the description and claims, the terms “comprise,” “including,” “having,” and “contain” and their variations should be understood as meaning “including but not limited to” and are not intended to exclude other components.

The present invention also covers the exact terms, features, values, and ranges, etc. in case these terms, features, values, and ranges, etc. are used in conjunction with terms such as about, around, generally, substantially, essentially, at least, etc. (i.e., “about 3” shall also cover exactly 3 or “substantially constant” shall also cover exactly constant).

It will be appreciated that variations to the foregoing embodiments of the invention can be made while still falling within the scope of the invention. Alternative features serving the same, equivalent, or similar purpose can replace features disclosed in the specification unless stated otherwise. Thus, unless stated otherwise, each feature disclosed represents one example of a generic series of equivalent or similar features.

Use of exemplary language, such as “for instance,” “such as,” “for example,” and the like, is merely intended to better illustrate the invention and does not indicate a limitation on the scope of the invention unless so claimed. Any steps or acts described in the specification may be performed in any order or simultaneously unless the context clearly indicates otherwise.

While the invention has been described in connection with what is presently considered to be the most practical and preferred embodiments, it is to be understood that the invention is not to be limited to the disclosed embodiments but, on the contrary, is intended to cover various modifications and equivalent arrangements included within the spirit and scope of the appended claims.

What is claimed:

1. A computer-implemented method implemented by one or more computers including each including hardware, including one or more processors, and software, the method comprising:
(A) presenting a poll question to a group of users;
(B) collecting user responses to the poll question, at least some of the user responses including a corresponding user reason;
(C) determining an aggregated prediction based on the user responses;
(D) determining a set of aggregated reasons based on user reasons provided with the user responses, wherein the determining of the set of aggregated reasons in (D) comprises:
(D)(1) converting the user reasons into high dimensional vectors using an embedding model;
(D)(2) applying a transformation to each textual input embedding such that the embeddings better cluster;
(D)(3) clustering the transformed textual input embeddings; and
(D)(4) summarization and rewriting texts that have been clustered;
(E) presenting a summary of the user responses, the summary including the aggregated prediction and an aggregated reason corresponding to the aggregated prediction;
(F) in response to the presenting, collecting modified user responses to the poll question, at least some of the user-modified responses including a corresponding modified user reason, wherein the modified user reason is selected from the set of aggregated reasons;
(G) in response to the collecting in (F), determining an updated aggregated prediction based on the modified user responses; and
(H) presenting a summary of the user responses, the summary including the updated aggregated prediction and an aggregated reason corresponding to the aggregated prediction.

2. The method of claim 1, wherein the poll question comprises a preset collection of responses.

3. The method of claim 1, wherein the user reasons collected in (B) comprise a free-form textual user input.

4. The method of claim 1, wherein the collecting in (B) occurs asynchronously.

5. The method of claim 1, wherein the aggregated prediction is determined as a simple average.

6. The method of claim 1, wherein the aggregated prediction is determined as a weighted average.

7. The method of claim 6, wherein the weighted average is determined using one or more weights based on user information.

8. The method of claim 7, wherein the user information used to determine the one or more weights is selected from one or more of age, gender, location, and profession.

9. The method of claim 7, wherein the user information for a particular user is based on a measure of accuracy of prior predictions made by the particular user.

10. The method of claim 1, wherein the set of aggregated reasons comprises a set of anonymized, aggregated, and/or rewritten reasons.

11. The method of claim 1, wherein the user reasons are aggregated and/or rewritten by machine learning.

12. A non-transitory computer-readable medium with one or more computer programs stored therein that, when executed by one or more processors, cause the one or more processors to perform at least the operations of the method of claim 1.

13. An article of manufacture comprising non-transitory computer-readable media having computer-readable instructions stored thereon, the computer-readable instructions including instructions for implementing a computer-implemented method, the method operable on a device comprising hardware including memory and at least one processor and running a service on the hardware, the method comprising the method of claim 1.

14. A device comprising:
(a) hardware including memory and at least one processor, and
(b) a service running on the hardware, wherein the service is configured to perform the method of claim 1.

15. A system comprising at least one device according to claim 14.
